(19) United States
(12) Patent Application Publication
(10) Pub. No.: US 2012/0223876 A1
(43) Pub. Date: Sep. 6, 2012

(54) ELECTRO-OPTICAL DEVICE AND ELECTRONIC APPARATUS

(75) Inventors: Takayuki KITAZAWA, Suwa-shi (JP); Shin FUJITA, Suwa-shi (JP); Toshiyuki KASAI, Okaya-shi (JP)

(73) Assignee: SEIKO EPSON CORPORATION, Tokyo (JP)

(21) Appl. No.: 13/407,008

(22) Filed: Feb. 28, 2012

(30) Foreign Application Priority Data
Mar. 2, 2011 (JP) 2011-044780

(51) Int. Cl. G09G 3/34

(52) U.S. Cl. 345/84

(57) ABSTRACT

An electro-optical device includes a first scanning line to which a first signal is supplied, a second scanning line to which a second signal is supplied, the second signal being an inverted signal of the first signal, a data line, a first capacitor having a first end and a second end, a first transistor that is controlled in accordance with the first signal, the first transistor electrically interposed between the data line and the first end of the first capacitor, a second capacitor electrically interposed between the second scanning line and the first end of the first capacitor, an electro-optical element that is controlled in accordance with an electric potential held by the first capacitor.

### BACKGROUND

1. Technical Field

The present invention relates to an electro-optical device and an electronic apparatus which are effective even when the display size is reduced.

2. Related Art

In recent years, various electro-optical devices which use an electro-optical element such as a liquid crystal element or an organic light emitting diode (hereinafter, referred to as “OLED”) have been proposed. Electro-optical devices include the following configuration in common. That is, a switching element and a holding capacitor are included in a pixel circuit, and the electric potential of a data line is held by the holding capacitor and an electro-optical element enters a state for displaying corresponding to the held electric potential when the switching element is turned on (is electrically connected).

In general, a transistor is used as the switching element. However, if field-through (penetration, also referred to as a “push down” if the transistor is an N-channel type and referred to as a “push up” if the transistor is a P-channel type) occurs, the voltage held by the holding capacitor is changed. Thereby, a technology has been proposed in which a complementary transmission gate is used as the switching element in the pixel circuit (for example, refer to JP-A-2009-198981).

However, in recent years, advances have been made regarding reduction of display size and increase in definition, and the size of pixel circuits has been reduced. Therefore, it may be difficult to produce a holding capacitor having sufficient capacitance. In the transmission gate, though field-through may be suppressed off-leakage, in turn, is high. Therefore, even though the holding capacitor can hold a voltage corresponding to the electric potential of the data line by turning on the transmission gate, the holding voltage is considerably decreased due to off-leakage, and a problem which adversely affects display quality occurs.

### SUMMARY

An advantage of some aspects of the invention is that a change in a voltage of a holding capacitor, which is caused by a field-through or an off-leakage, may be suppressed.

According to an aspect of the invention, there is provided an electro-optical device including: a plurality of pixel circuits that are provided so as to correspond to intersections of a plurality of scanning lines and a plurality of data lines; and a plurality of reverse scanning lines to which a signal, which has a reverse logic relationship with respect to signals supplied to the plurality of scanning lines, is supplied, and each of the pixel circuits includes: a first transistor that is controlled in accordance with a signal supplied to one of the scanning line and the reverse scanning line; a first capacitor in which one end is electrically connected to the first transistor, the first capacitor holding an electric potential of the data line; a second capacitor that is electrically interposed between one end of the first capacitor and the other one of the scanning line and the reverse scanning line; and an electro-optical element that is controlled in accordance with the electric potential held by the first capacitor.

According to an aspect of the invention, there is provided an electro-optical device including: a first scanning line to which a first signal is supplied; a second scanning line to which a second signal is supplied, the second signal being an inverted signal of the first signal; a data line; a first capacitor having a first end and a second end; a first transistor that is controlled in accordance with the first signal, the first transistor electrically interposed between the data line and the first end of the first capacitor; a second capacitor electrically interposed between the second scanning line and the first end of the first capacitor; an electro-optical element that is controlled in accordance with an electric potential held by the first capacitor.

According to the aspect of the invention, for example, when the signal level supplied to the scanning line or the reverse scanning line is changed and the first transistor is changed from the electrically connected state to the non-electrically connected state, since a change of the signal level in the reverse direction from the other side to the one side is propagated via the second capacitor, a field-through is prevented. In addition, when the first transistor is a non-complementary type, the effect of an off-leakage is also decreased. Thereby, it is possible to suppress the voltage change of the holding capacitor which is generated due to the field-through and the off-leakage.

In the electro-optical device, the first transistor may be either of an N-channel type or a P-channel type, a gate electrode of the first transistor may be electrically connected to either of the scanning line and the reverse scanning line, a drain electrode of the first transistor may be electrically connected to the data line, and a source electrode of the first transistor may be electrically connected to one end of the first capacitor.

In the electro-optical device, a third capacitor, which is electrically interposed between the one end of the first capacitor and one of the scanning line and the reverse scanning line, may be provided. According to the electro-optical device, the capacitance of the second capacitor may be determined on the basis of the sum of a parasitic capacitance between the gate and the source and the capacitance of the third capacitor in the first transistor, and may be adjusted to the same degree as the sum. Therefore, the second capacitor does not need to have a minute capacitance.

On the other hand, if the third capacitor is not provided, the capacitance of the second capacitor may be determined on the basis of a parasitic capacitance between the gate and the source in the first transistor, and may be adjusted to the same degree as the parasitic capacitance. In the above configuration, since the third capacitor is not provided, miniaturization of the pixel circuit can be easily realized.

In the electro-optical device, a second transistor, which makes current corresponding to the electric potential held by the first capacitor flow into the electro-optical element, may be provided. When the second transistor is provided, an organic EL element is suitable as the electro-optical element. Moreover, other than the above, a liquid crystal element which becomes a transmittance (or reflectance) corresponding to a holding voltage may be used as the electro-optical element. Since the liquid crystal element is a voltage-driven type, a second transistor for flowing current is not needed.

In addition, the electro-optical device according to the aspect of the invention may be applied to various electronic apparatuses. Typically, the electro-optical device is a display device, and there is a personal computer or a portable telephone as the electronic apparatus. Particularly, in the aspect of the invention, even though the holding capacitor cannot be sufficiently secured, a voltage change due to the field-through or the off-leakage can be suppressed. Therefore, for example, the electro-optical device according to the aspect of the invention is suitable for a display device which forms a reduced image such as a head mounted display or a projector. Above all, use of the electro-optical device according to the aspect of the invention is not limited to a display device. For example, the electro-optical device according to the aspect of the invention may be also applied to an exposure apparatus (an optical head) for forming a latent image on an image carrier such as a photosensitive drum by irradiation of light rays.

### BRIEF DESCRIPTION OF THE DRAWINGS

The invention will be described with reference to the accompanying drawings, wherein like numbers reference like elements.

FIG. 1 is a block diagram showing the configuration of an electro-optical device according to a first embodiment of the invention.

FIG. 2 is a diagram showing an equivalent circuit of a pixel of the electro-optical device.

FIG. 3 is a diagram showing a display operation of the electro-optical device.

FIG. 4 is a diagram showing an equivalent circuit of a pixel of an electro-optical device according to a second embodiment.

FIG. 5 is a diagram showing an equivalent circuit of a pixel of an electro-optical device according to an application and a modification.

FIG. 6 is a perspective diagram showing an electronic apparatus (the first) to which the electro-optical device is applied.

FIG. 7 is a perspective diagram showing an electronic apparatus (the second) to which the electro-optical device is applied.

FIG. 8 is a perspective diagram showing an electronic apparatus (the third) to which the electro-optical device is applied.

FIG. 9 is a diagram showing an equivalent circuit of a pixel according to a comparative example (the first).

FIG. 10 is a diagram showing a display operation of the comparative example (the first).

FIG. 11 is a diagram showing an equivalent circuit of a pixel according to a comparative example (the second).

FIG. 12 is a diagram showing a display operation of the comparative example (the second).

### DESCRIPTION OF EXEMPLARY EMBODIMENTS

### First Embodiment

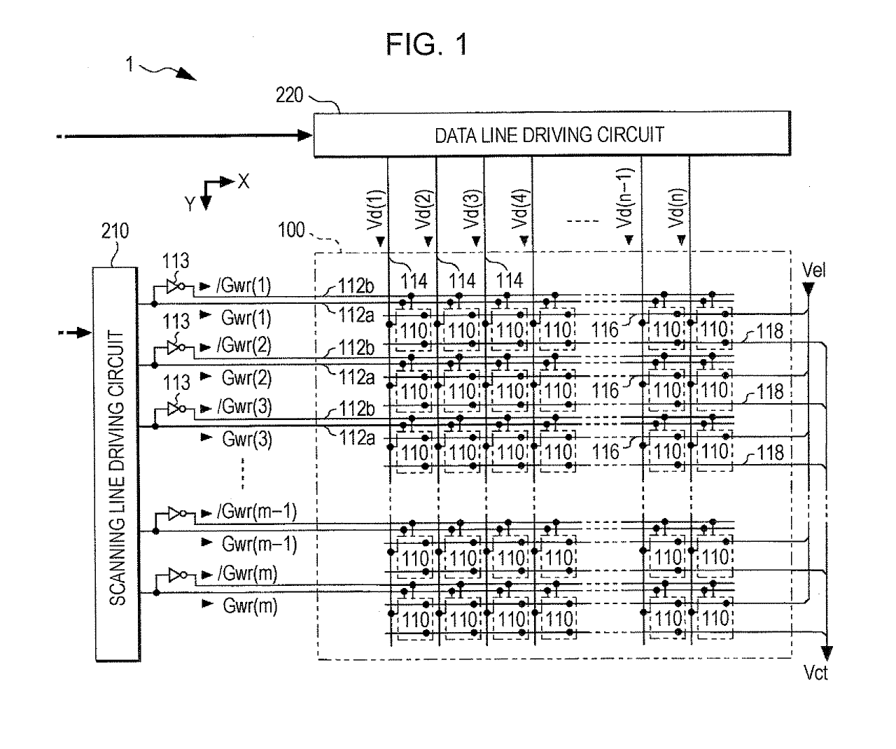

FIG. 1 is a block diagram showing the configuration of an electro-optical device 1 according to a first embodiment of the invention. An electro-optical device 1 is one which displays an image by using a plurality of pixel circuits 110.

As shown in FIG. 1, the electro-optical device 1 includes an element portion 100, a scanning line driving circuit 210, and a data line driving circuit 220.

Among these, in the element portion 100, as shown in FIG. 1, scanning lines 112a of m rows are provided along the row (X) direction. Data lines 114 of n columns are provided along the column (Y) direction so as to maintain mutual electrical insulation with each scanning line 112a. The pixel circuits 110 are disposed so as to correspond to the intersections of scanning lines 112a of m rows and data lines 114 of n columns. Accordingly, in the present embodiment, the pixel circuits 110 are arranged in a matrix form with m rows vertically and n columns horizontally. In addition, both m and n are a natural number.

Moreover, reverse scanning lines 112b are provided along the X direction so as to form pairs with the scanning lines 112a of m rows and so as to be mutually electrically insulated with the data lines 114.

Power feeding lines 116 and 118 are connected in common to each pixel circuit 110. The power feeding line 116 supplies a high side electric potential Vel of an element power supply, and the power feeding line 118 supplies a low side electric potential Vct of the element power supply. The electric potentials Vel and Vct are generated by a power supply circuit (not shown).

Moreover, for convenience to distinguish the scanning lines 112a, the reverse scanning lines 112b, and the rows of the pixel circuits 110, these are called the 1st row, 2nd row, 3rd row, . . . , (m−1)th row, and mth row in order from the top in FIG. 1. Similarly, for convenience to distinguish the data lines 114 and the columns of the pixel circuits 110, these are called the 1st column, 2nd column, 3rd column, (n−1)th column, and nth column in order from the left in FIG. 1.

In the electro-optical device 1, a scanning line driving circuit 210, a data line driving circuit 220, and inverters 113 are disposed in the periphery of a region in which the pixel circuits 110 are arranged in matrix form. Operations of the scanning line driving circuit 210 and the data line driving circuit 220 are controlled by a controller (not shown). Moreover, in the data line driving circuit 220, grayscale data which designates a grayscale (brightness) for each pixel circuit 110 is supplied from the controller.

The scanning line driving circuit 210 sequentially and exclusively selects the 1st row to the mth row for each frame. Specifically, the scanning line driving circuit 210 supplies scanning signals Gwr(1), Gwr(2), Gwr(3), Gwr(m−1), and Gwr(m) respectively to the scanning lines 112a of the 1st, the 2nd, the 3rd, . . . , the (m−1)th, and the mth rows, and sequentially and exclusively makes each scanning signal have an H level. Note that, in the present description, the term “frame” refers to a period which is needed to display a still image (picture) on the electro-optical device 1, and the period is 16.67 milliseconds if the vertical scanning frequency is 60 Hz.

The inverters 113 are each provided on the scanning line 112a of each row. The inverter 113 of a certain row logically reverses the scanning signal which is supplied to the scanning line 112a of the corresponding row, and supplies the reversed signal to the reverse scanning line 112b as a reverse scanning signal. That is, the reverse scanning signal has a low level electric potential which is lower than a high level electric potential when the scanning signal has a high level electric potential, and the reverse scanning signal has a high level electric potential which is higher than a low level electric potential when the scanning signal has a low level electric potential. For convenience, the reverse scanning signals, which are supplied to the reverse scanning lines 112b of the 1st, the 2nd, the 3rd, . . . , the (m−1)th, and the mth rows respectively, are denoted as /Gwr(1), /Gwr(2), /Gwr(3), . . . , /Gwr(m−1), and /Gwr(m).

The data line driving circuit 220 supplies the data signal, which is applied as an electric potential through the data line 114, that corresponds to the designated signal level of the pixel circuit 110 to the pixel circuit 110 selected by the scanning line driving circuit 210. For convenience, the data signals, which are supplied to the data lines 114 of the 1st, the 2nd, the 3rd, . . . , the (n−1)th, and the nth columns respectively, are denoted as Vd(1), Vd(2), Vd(3), . . . , Vd(n−1), and Vd(n).

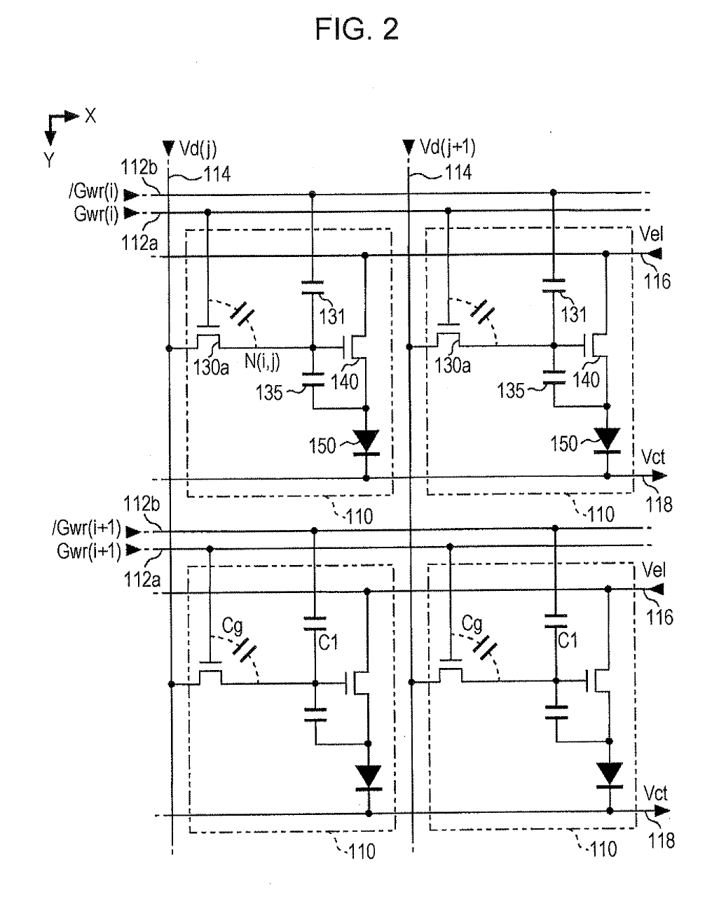

Next, an equivalent circuit of the pixel circuit 110 will be described with reference to FIG. 2. Moreover, in FIG. 2, there are a total of four pixels in a 2×2 arrangement, the pixel corresponds to intersections of the scanning lines 112a of the ith row and the (i+1)th row which is adjacent to and below the ith row and the data lines 114 of the jth column and the (j+1)th column which is adjacent to and to the right of the jth column. Here, i and (i+1) generally indicate the rows in which the pixel circuits 110 are arranged, and are integers which are equal to or greater than 1 and equal to or less than m. Similarly, j and (j+1) generally indicate the columns in which the pixel circuits 110 are arranged, and are integers which are equal to or greater than 1 and equal to or less than n.

As shown in FIG. 2, each pixel circuit 110 includes N-channel type transistors 130a and 140, a capacitive element 131, a holding capacitor 135, and a light emitting element 150. Since each pixel circuit 110 has the same configuration, the pixel circuit which is positioned at the ith row and the jth column is described as a representative example. In the pixel circuit 110 of the ith row and the jth column, a gate electrode of the transistor (first transistor) 130a is connected to the scanning line 112a of the ith row, a drain electrode of the transistor is connected to the data line 114 of the jth column, and a source electrode of the transistor is connected to one end of the capacitive element 131, one end of the holding capacitor 135, and the gate electrode of the transistor 140 respectively.

For convenience, in the pixel circuit 110 of the ith row and the jth column, a connection point of the source electrode of the transistor 130a, the gate electrode of the transistor 140, one end of the capacitive element 131, and one end of the holding capacitor are referred to as a node N(i,j).

The other end of the capacitive element (first capacitive element) 131 is connected to the reverse scanning line 112b of the ith row. Thereby, the capacitive element 131 is constituted so as to be electrically interposed between the node N(i,j) and the reverse scanning line 112b.

In addition, the other end of the holding capacitor 135 is connected to each of the source electrode of the transistor 140 and an anode of the light emitting element 150. The drain electrode of the transistor (second transistor) 140 is connected to the power feeding line 116.

On the other hand, a cathode of the light emitting element 150 is connected to the power feeding line 118. The light emitting element 150 is an OLEO in which a light emitting layer composed of an organic EL material is interposed between an anode and a cathode which face each other, and the light emitting element emits brightness corresponding to the current which flows between the anode and the cathode.

In FIG. 2, Gwr(i) and Gwr(i+1) each represent the scanning signals which are supplied to the scanning line 112a of the ith and (i+1)th rows, and /Gwr(i) and /Gwr(i+1) each represent the reverse scanning signals which are supplied to the reverse scanning lines 112b of the ith and (i+1)th rows. Vd(1) and Vd(j+1) each represent the data signals which are supplied to data lines 114 of the jth and the (j+1)th columns. In addition, the capacitance of the capacitive element 131 is denoted by C1, and a parasitic capacitance between the gate and the drain of the transistor 130a is denoted as Cg.

In the element portion 100, typically, the transistors 130a and 140 are TFTs (Thin Film Transistors) and formed by performing a common silicon process on a surface of a substrate such as glass. Various wirings such as the scanning lines 112a (reverse scanning lines 112b) and the data lines 114 are also formed by performing the silicon process. For example, the scanning lines 112a and the reverse scanning lines 112b are formed by patterning a conductive layer which becomes the gate electrode of the TFT.

In addition, for example, the capacitive element 131 is formed by interposing an insulating film between electrodes in which different conductive layers are patterned. The gate electrode of the transistor 140 may be used as one of the electrodes. The capacitance C1 of the capacitive element 131 is formed so as to be about the same as the parasitic capacitance Cg in the transistor 130a.

In addition, not only the element portion 100 but also the scanning driving circuit 210, the data line driving circuit 220, and the inverter 113 may be formed by performing the common silicon process.

When various circuits are formed by the process, in some cases, a certain electrode and the other electrode are connected to each other via a contact hole, or a resistor or other elements in the middle of the wiring path. In this case, the connection is not a direct connection from the physical viewpoint, but the connection refers to a connected state from the electrical viewpoint.

Moreover, a silicon single-crystal film is formed on an insulating substrate such as sapphire, quartz, or glass by applying SOI (Silicon On Insulator) technology of a, and various elements may be formed on the film or on the silicon substrate. If the silicon substrate is used, a high speed field-effect type transistor can be used as a switching element, an operation having a higher speed than that of the TFT is easily performed.

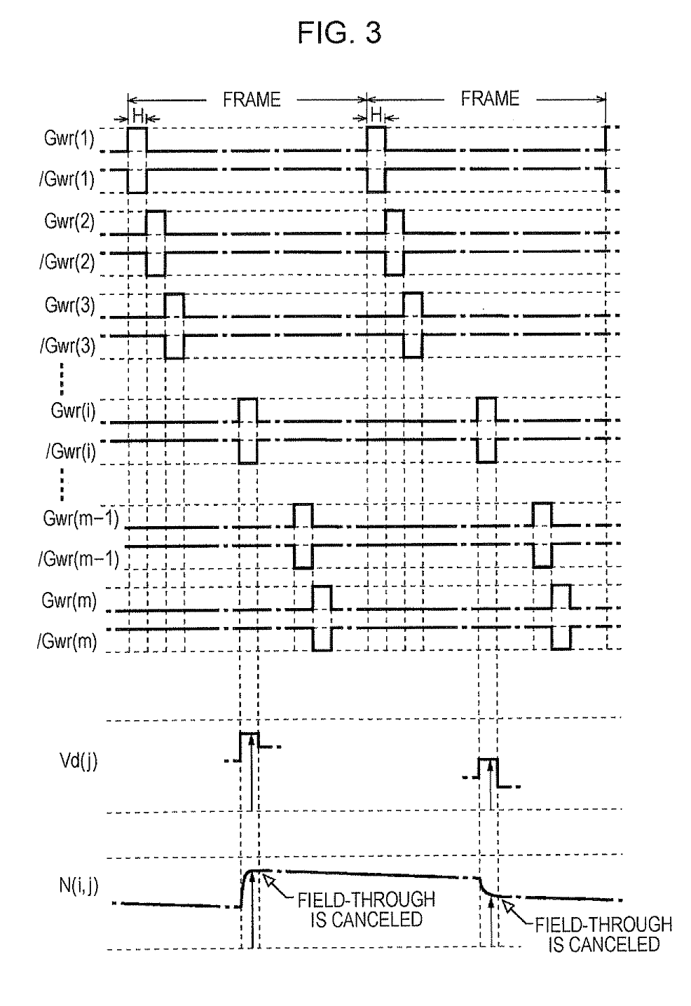

Next, the display operation of the electro-optical device 1 will be described with reference to FIG. 3. FIG. 3 is a diagram showing an example of waveforms of the scanning signal and the data signal.

As shown in FIG. 3, the scanning signals Gwr(1), Gwr(2), Gwr(3), . . . , Gwr(m−1), and Gwr(m) sequentially and exclusively have an H level for one frame for each horizontal scanning period (H) by the scanning line driving circuit 210. The scanning signals are each logically reversed by the inverter 113 and become reverse scanning signals. Thereby, as shown in FIG. 3, the reverse scanning signals /Gwr(1), /Gwr(2), /Gwr(3), . . . , /Gwr(m−1), and /Gwr(m) sequentially and exclusively have an L level for each horizontal scanning period(H).

Here, when the scanning line 112a of the ith row is selected and the scanning signal Gwr(i) has an H level, the data signal Vd(j) of the electric potential corresponding to the grayscale data of the pixel circuit 110 of the ith row and the jth column is supplied to the data line 114 of the jth column by the data line driving circuit 220.

If the scanning signal Gwr(i) has the H level, since the transistor 130a is turned on in the pixel circuit 110 of the ith row and the jth column, the node N(i,j) is electrically connected to the data line 114. Thereby, as shown by an upward arrow in FIG. 3, the electric potential of the node N(i,j) becomes the electric potential of the data signal Vd(j). At this time, the transistor 140 makes the current corresponding to the electric potential of the node N(i,j) flow to the light emitting element 150, and simultaneously, the holding capacitor 135 maintains the voltage between the gate and the source of the transistor 140 at this time.

When the selection of the scanning line 112a of the ith row ends and the scanning signal Gwr(i) becomes an L level, the transistor 130a is turned off. At this time, in the node N(i,j), a voltage fluctuation caused by a voltage change of the scanning signal Gwr(i), from the H level to the L level, is transmitted due to the parasitic capacitance Cg, and field-through occurs. Therefore, the field-through decreases the electric potential of the data signal Vd(j). However, in the node N(i,j), since a voltage fluctuation caused by another voltage change of the scanning signal /Gwr(i), from the L level to the H level, is transmitted due to the capacitive element 131, the field-through due to the transistor 130a is offset by that due to the parasitic capacitance.

As a result, the electric potential of the node N(i,j) is substantially not changed even though the level of the scanning signal Gwr(i) is changed from the H level to the L level.

Also when the transistor 130a is turned from on to off, the voltage between the gate and the source of the transistor 140 at the time of the turned-on state is maintained by the holding capacitor 135. Therefore, even though the transistor 130a is turned off, the transistor 140 continuously makes the current corresponding to the holding voltage of the holding capacitor 135 flow into the light emitting element 150 until the ith scanning line 112a is selected again. Therefore, the light emitting element 150 in the pixel circuit 110 of the ith row and the jth column emits light over a period corresponding to one frame with a brightness corresponding to the electric potential of the data signal Vd(j) when the ith row is selected, that is, with a brightness corresponding to the grayscale data of the ith row and jth column.

In practice, as shown in FIG. 3, the electric potential of the node N(i,j) is decreased by an off-leakage of the transistor 130a with time. However, the effect of the off-leakage can be ignored in the present embodiment.

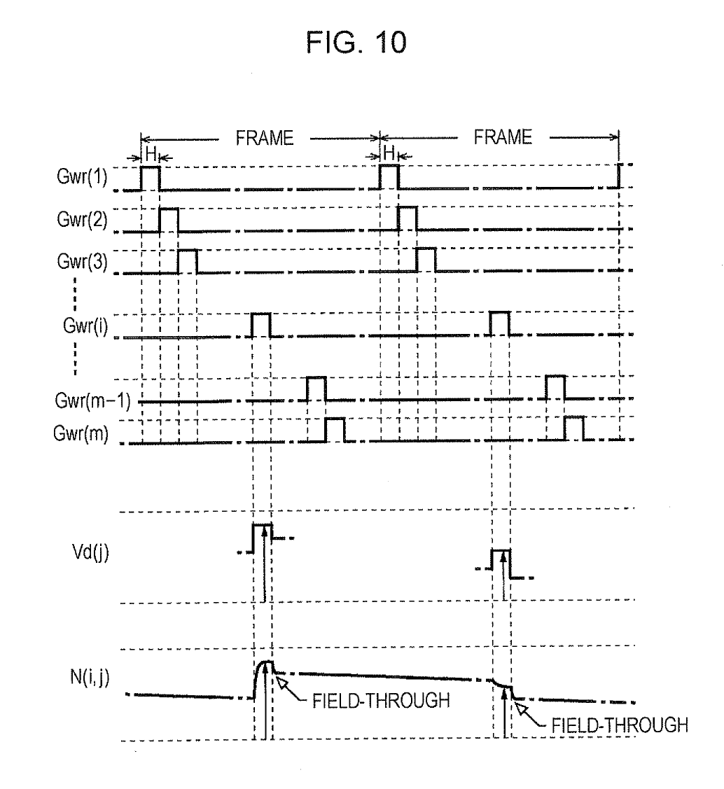

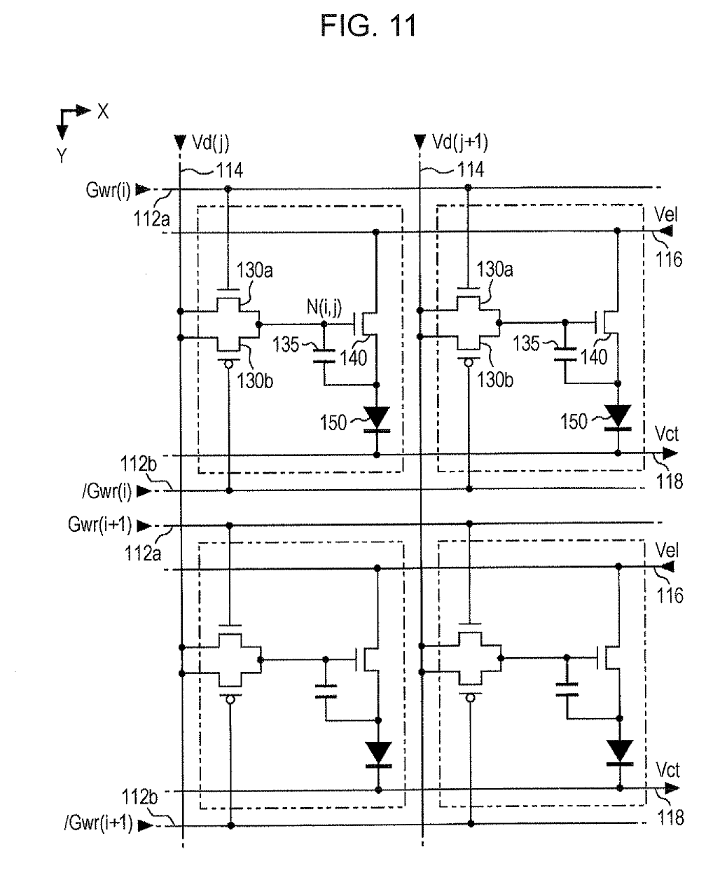

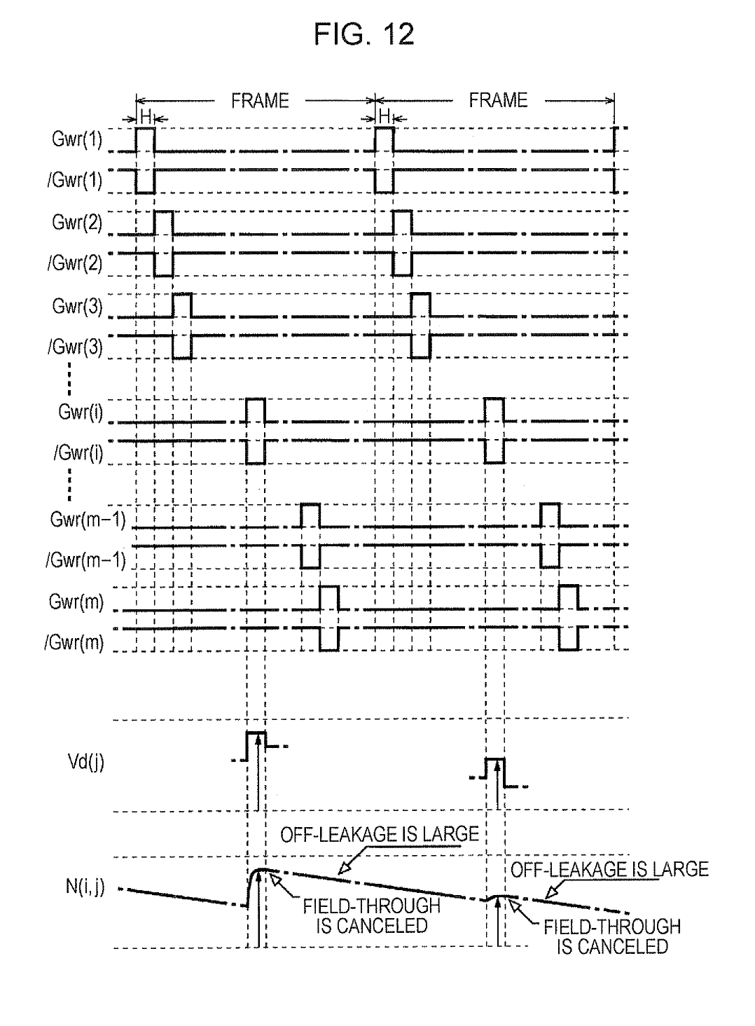

Moreover, in the ith row, the pixel circuits 110 other than those of the jth column emit light with a brightness corresponding to the electric potential of the data signal which is supplied to the corresponding data line 114. Here, the pixel circuit 110 corresponding to the scanning line 112a of the ith row is described. However, the scanning line 112a is selected in the order of the 1st, 2nd, 3rd, . . . , the (m−1)th, and the mth rows, and as a result, the pixel circuits 110 each emit light with a brightness corresponding to a respective grayscale data. This operation is repeated for each frame. Moreover, in FIG. 3, for convenience, scales for the data signal and the electric potential of the node N(i,j) are increased rather than the scale of electric potential of the scanning signal (reverse scanning signal) (this is similarly applied to FIGS. 10 and 12).

Here, the superiority of the embodiment will be described with reference to two comparative examples. FIG. 9 is a diagram showing an equivalent circuit of a pixel circuit according to a comparative example (the first), and FIG. 10 is a diagram showing a display operation of the comparative example.

As shown in FIG. 9, the comparative example (the first) does not have the capacitive element 131. Thereby, as shown in FIG. 10, since the change to the L level of the scanning signal Gwr(i) is propagated via the parasitic capacitance Cg in the node N(i,j), field-through occurs. Accordingly, in the comparative example (the first), the brightness corresponding to the electric potential of the data signal Vd(j) cannot be emitted when the light emitting element 150 is selected.

FIG. 11 is a diagram showing an equivalent circuit of a pixel circuit according to a comparative example (the second), and FIG. 12 is a diagram showing a display operation of the comparative example.

As shown in FIG. 11, in the comparative example (the second), the capacitive element 131 is not provided. However, a transmission gate which combines an N-channel type transistor 130a and a P-channel type transistor 130b in a complementary style is used as a switching element.

As shown in FIG. 12, in the comparative example (the second), when the scanning signal Gwr(i) is changed from the H level to the L level and the reverse scanning signal /Gwr(i) is changed from the L level to the H level, the push down by the transistor 130a and the push up by the transistor 130b are cancelled by each other. Thereby, the electric potential of the node N(i,j) is almost unchanged when viewing at the moment of turning off the transistors 130a and 130b.

However, in general, the off-leakage in the P-channel type transistor 130b is greater than the off-leakage in the N-channel type transistor 130a, and the two transistors 130a and 130b are connected to each other in parallel. Thereby, in the comparative example (the second), the electric potential of the node N(i,j) is considerably more decreased compared to the embodiment in the term when the transmission gate is turned off. Therefore, in the comparative example (the second), the brightness corresponding to the electric potential of the data signal Vd(j) cannot be continuously emitted in a stable state when the light emitting element 150 is selected.

According to the embodiment with respect to the (first) comparative example and the (second) comparative example, due to the fact that the field-through can be prevented and the off-leakage is smaller at the moment of turning the transistor 130a off, the brightness corresponding to the electric potential of the data signal Vd(j) can be continuously emitted in a stable state when the light emitting element 150 is selected.

### Second Embodiment

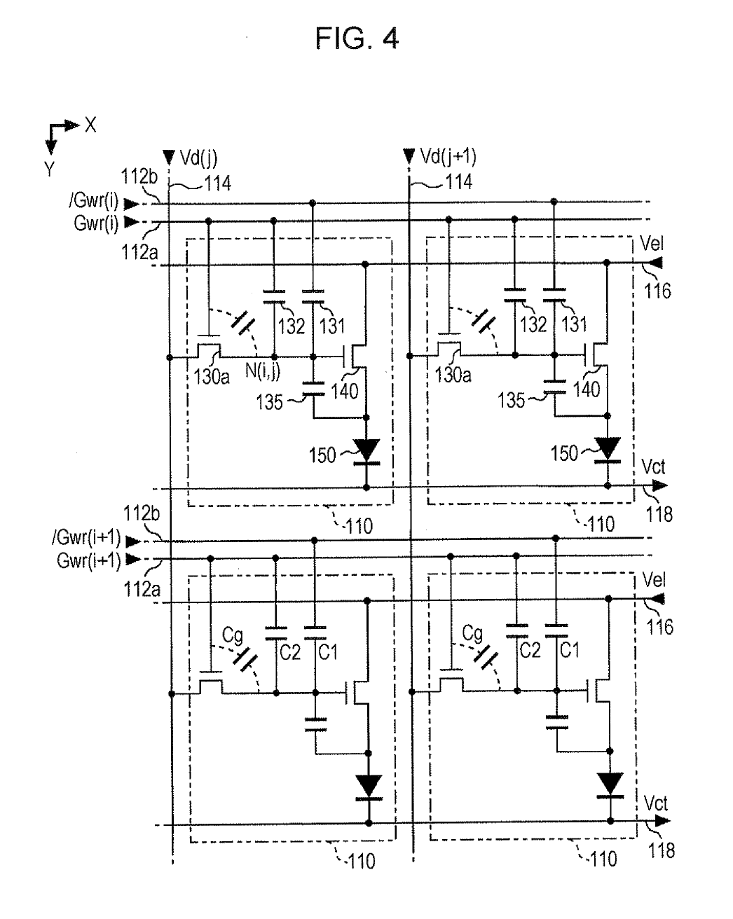

Next, a second embodiment of the invention will be described. FIG. 4 is a diagram showing an equivalent circuit in a pixel circuit of an electro-optical device according to the second embodiment.

In the pixel circuit shown in FIG. 4 compared to the first embodiment shown in FIG. 2, a capacitive element (second capacitive element) 132 is electrically interposed between the node N(i,j) and the scanning line 112a. In the second embodiment, when the capacitance of the capacitive element 132 is denoted as C2, the capacitance C1 of the capacitive element 131 is adjusted so as to be the sum of the capacitance C2 of the capacitive element 132 and the parasitic capacitance Cg of the transistor 130a.

Since the capacitance Cg is the parasitic capacitance of the transistor 130a, in practice, the capacitance Cg is minute. Thereby, unlike the first embodiment, it is considered that it is difficult to form the capacitive element 131 which is the same degree as the minute capacitance Cg with high accuracy.

In the second embodiment, even though the capacitance Cg is minute, if the capacitance C1 is formed so as to be slightly greater than the capacitance C2, the capacitance C1 can be approximately the same as the sum of the capacitance C2 and the parasitic capacitance Cg.

In other words, even in the case of Cg<<C1, C2, if the capacitive elements 131 and 132 are formed so as to be C1≅C2 (C2<C1), C1=C2+Cg is possible.

For example, even when the capacitive elements 131 and 132 are formed to have a greater capacitance with respect to the Cg, if the C1=10·Cg and C2=9·Cg, C1=C2+Cg is possible.

According to the second embodiment, even when the minute capacitance which is the same degree as the parasitic capacitance cannot be formed alone, the field-through can be easily prevented.

However, in the second embodiment, since not only the capacitive element 131 but also the capacitive element 132 need to be formed, the second embodiment is somewhat disadvantageous compared to the first embodiment from the viewpoint of miniaturization in the scale of the pixel circuit 110. In other words, the first embodiment is somewhat advantageous compared to the second embodiment from the viewpoint of miniaturization of the scale of the pixel circuit 110.

### Application and Modification

The invention is not limited to the above-described embodiments and can be applied and modified as follows.

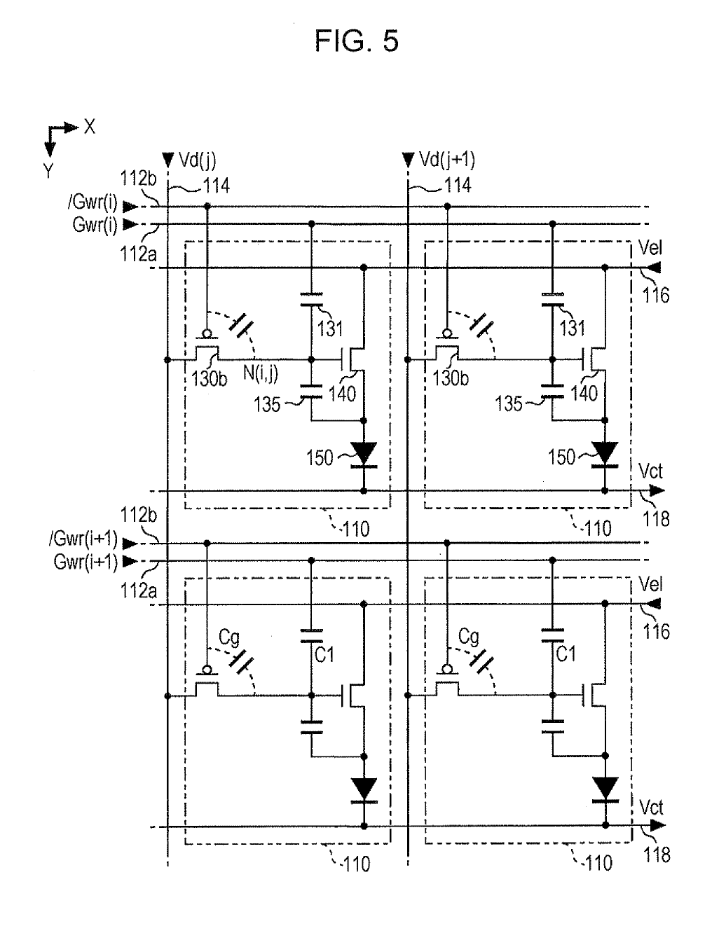

For example, in the first embodiment and the second embodiment, the N-channel type transistor 130a is used as the switching element. However, as shown in FIG. 5, the P-channel type transistor 130b may be used.

At this time, since the gate electrode of the P-channel type transistor 130b is connected to the reverse scanning line 112b, the capacitive element 131 is electrically interposed between the node N(i,j) and the scanning line 112a.

In addition, if the P-channel type transistor 130b is used as the switching element, the off-leakage is greater compared to that of the N-channel type transistor 130a, but the off-leakage of the P-channel type transistor 130b is smaller compared to the transmission gate which is connected in parallel.

Moreover, particularly, even though not shown, in the configuration in which the P-channel type transistor 130b is used as the switching element, the capacitive element 132 may be electrically interposed between the node N(i,j) and the reverse scanning line 112b and the capacitance C1 may be the approximately same as the sum of the capacitance C2 and the parasitic capacitance Cg similarly to the second embodiment.

The electro-optical element is not limited to the light emitting element. That is, a liquid crystal element in which a liquid crystal layer is interposed between electrodes may be used as the electro-optical element. When the liquid crystal element is used, in the pixel circuit 110, the liquid crystal layer is interposed by the pixel electrode and the common electrode which are connected to the node N(i,j). Thereby, the transistor 140 or the power feeding lines 116 and 118 of the element power supply are not needed. Moreover, the liquid crystal element becomes the transmittance or the reflectance corresponding to the electric potential of the node N(i,j). In addition, in the configuration, the liquid crystal element itself becomes the holding capacitor, or the parallel connection with an auxiliary capacitance which is separately added to the liquid crystal element becomes the holding capacitor.

### Electronic Apparatus

Next, some electronic apparatuses to which the electro-optical device according to the invention is applied will be described.

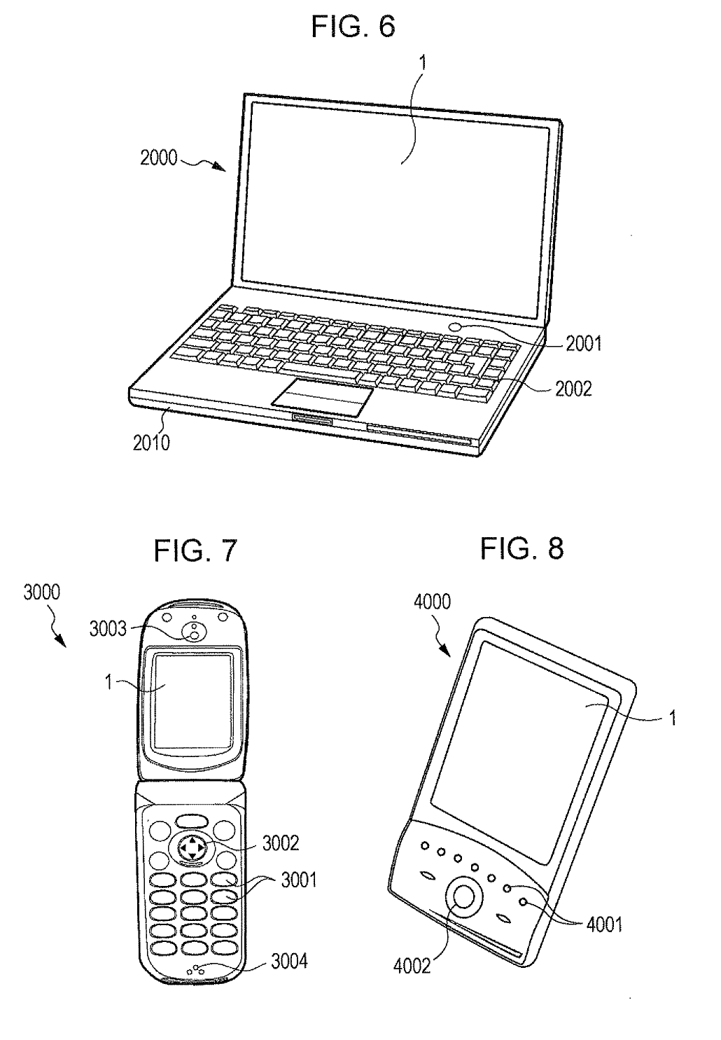

FIG. 6 is a diagram showing an outline of a personal computer which adopts the electro-optical device 1 according to the above-described embodiments as a display device. The personal computer 2000 includes the electro-optical device 1 as the display device and a main portion 2010. A power switch 2001 and a keyboard 2002 are provided on the main portion 2010.

In the electro-optical device 1, when the OLED is used in the light emitting element 150, the viewing angle is wide and the screen display can be easily viewed.

FIG. 7 is a diagram showing an outline of a portable telephone which adopts the electro-optical device 1 according to the above-described embodiments as a display device. The portable telephone 3000 includes the above-described electro-optical device 1 along with an ear piece 3003 and a mouth piece 3004 in addition to a plurality of operation buttons 3001, a cursor key 3002, or the like. The screen which is displayed on the electro-optical device 1 is scrolled by operating the cursor key 3002.

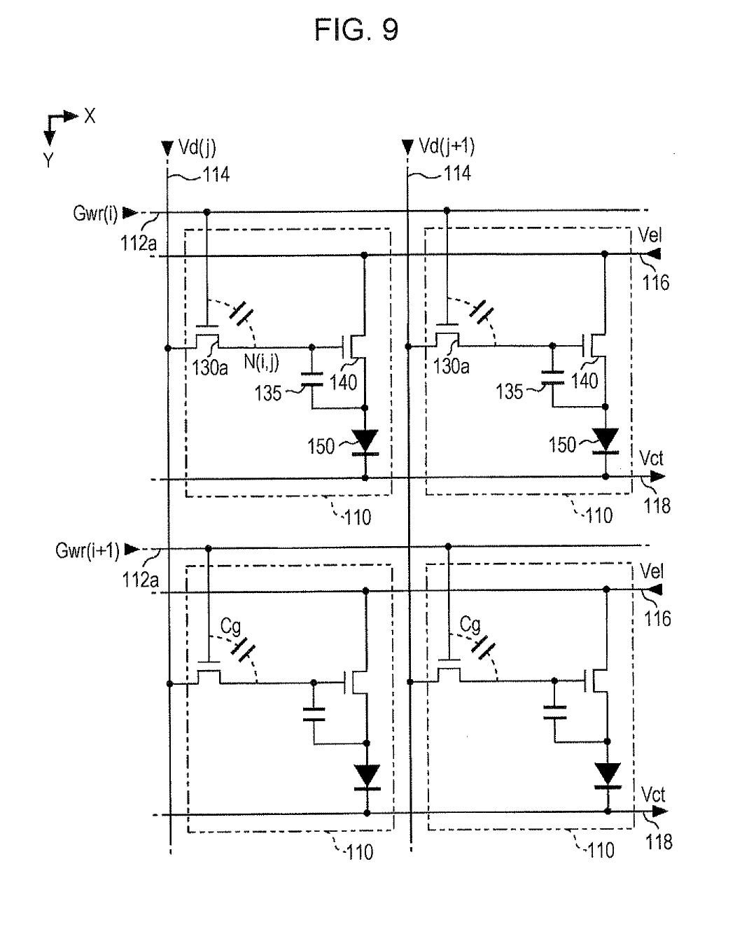

FIG. 8 is a diagram showing an outline of a Personal Digital Assistant (PDA) which adopts the electro-optical device 1 according to the embodiments as a display device. The personal digital assistant 4000 includes the above-described electro-optical device 1 in addition to a plurality of operation buttons 4001, a cursor key 4002, or the like. In the personal digital assistant 4000, a variety of information such as an address book or a diary is displayed on the electro-optical device 1 by a predetermined operation and the displayed information is scrolled according to the operation of the cursor key 4002.

In addition, as the electronic apparatuses to which the electro-optical device according to the invention is applied, in addition to the examples which are shown in FIGS. 6 to 8, there are a digital still camera, a head mount display, a television, a video camera, a car navigation apparatus, a pager, an electronic organizer, an electronic paper, an electronic calculator, a word processor, a work station, a video telephone, a POS terminal, a printer, a scanner, a copying machine, a video player, an equipment having a touch panel, and the like.

This application claims priority to Japanese Patent Application No. 2011-044780 filed on Mar. 2, 2011. The entire disclosure of Japanese Patent Application No. 2011-044780 is hereby incorporated herein by reference.

What is claimed is:

1. An electro-optical device comprising:
a plurality of pixel circuits that are provided so as to correspond to intersections of a plurality of scanning lines and a plurality of data lines; and
a plurality of reverse scanning lines to which a signal, which has a reverse logic relationship with respect to signals supplied to the plurality of scanning lines, is supplied,
wherein each of the pixel circuits includes:
a first transistor that is controlled in accordance with a signal supplied to one of the scanning line and the reverse scanning line;
a first capacitor in which one end is electrically connected to the first transistor, the first capacitor holding an electric potential of the data line;
a second capacitor that is electrically interposed between one end of the first capacitor and the other one of the scanning line and the reverse scanning line; and
an electro-optical element that is controlled in accordance with the electric potential held by the first capacitor.

2. The electro-optical device according to claim 1,
wherein the first transistor is either of an N-channel type or a P-channel type,
a gate electrode of the first transistor is electrically connected to one of the scanning line and the reverse scanning line,
a drain electrode of the first transistor is electrically connected to the data line, and
a source electrode of the first transistor is electrically connected to one end of the first capacitor.

3. The electro-optical device according to claim 2 further comprising,
a third capacitor, which is electrically interposed between the one end of the first capacitor and one of the scanning line and the reverse scanning line.

4. The electro-optical device according to claim 3,
wherein the capacitance of the second capacitor is determined on the basis of the sum of a parasitic capacitance between the gate and the source and the capacitance of the third capacitor in the first transistor.

5. The electro-optical device according to claim 2,
wherein the capacitance of the second capacitor is determined on the basis of a parasitic capacitance between the gate and the source in the first transistor.

6. The electro-optical device according to claim 1 further comprising,
a second transistor, which makes current corresponding to the electric potential held by the first capacitor flow into the electro-optical element.

7. An electro-optical device comprising:
a first scanning line to which a first signal is supplied;
a second scanning line to which a second signal is supplied, the second signal being an inverted signal of the first signal;
a data line;
a first capacitor having a first end and a second end;
a first transistor that is controlled in accordance with the first signal, the first transistor electrically interposed between the data line and the first end of the first capacitor;
a second capacitor electrically interposed between the second scanning line and the first end of the first capacitor;
an electro-optical element that is controlled in accordance with an electric potential held by the first capacitor.

8. An electronic apparatus comprising the electro-optical device according to claim 1.

9. An electronic apparatus comprising the electro-optical device according to claim 2.

10. An electronic apparatus comprising the electro-optical device according to claim 3.

11. An electronic apparatus comprising the electro-optical device according to claim 4.

12. An electronic apparatus comprising the electro-optical device according to claim 5.

13. An electronic apparatus comprising the electro-optical device according to claim 6.

14. An electronic apparatus comprising the electro-optical device according to claim 7.
